(19) United States
(12) Patent Application Publication
(10) Pub. No.: US 2021/0295395 A1
(43) Pub. Date: Sep. 23, 2021

(54) INFORMATION PROVIDING SYSTEM

(71) Applicant: HONDA MOTOR CO., LTD., Tokyo (JP)

(72) Inventors: Noboru Kawaguchi, Wako-shi (JP); Masanori Fujinuma, Wako-shi (JP); Sei Watanabe, Wako-shi (JP); Tomoyuki Kuriyama, Tokyo (JP); Yutaka Tsuji, Tokyo (JP)

(21) Appl. No.: 17/204,144

(22) Filed: Mar. 17, 2021

(30) Foreign Application Priority Data
Mar. 19, 2020 (JP) 2020-049809

(51) Int. Cl. G06Q 30/02

(52) U.S. Cl. CPC G06Q 30/0281; G06Q 30/0278; G06Q 30/0206

(57) ABSTRACT

Provided is an information providing system capable of promoting the use of services relating to a lawn. The information providing system includes a gardener terminal and a customer terminal communicably connected to the gardener terminal. The gardener terminal includes the first fee setting unit that, in a case in which a contract for a transaction relating to a lawn is established between the customer using the customer terminal and the gardener using the gardener terminal, sets a first fee for the transaction relating to the lawn, based on an amount of the lawn produced by the transaction relating to the lawn, and the lawn state information generating unit that generates lawn state information including a use state of the lawn and the first fee, and transmits the lawn state information to the customer terminal.

This application is based on and claims the benefit of priority from Japanese Patent Application No. 2020-049809, filed on 19 Mar. 2020, the content of which is incorporated herein by reference.

### BACKGROUND OF THE INVENTION

### Field of the Invention

The present invention relates to an information providing system.

### Related Art

Conventionally, in order to protect the global environment and effectively utilize resources, various technologies for recycling and reusing plants have been proposed (for example, refer to Japanese Unexamined Patent Application, Publication No. 2005-71343). The technique disclosed in Japanese Patent Application Laid-Open No. 2005-71343 discloses that, in order to promote recycling, the selling price of organic materials made from waste plants is discounted in accordance with the collection fee of waste plants.

Patent Document 1: Japanese Unexamined Patent Application,

Publication No. 2005-71343

### SUMMARY OF THE INVENTION

Lawns used in parks, hotels, event halls, golf courses, and the like require periodic maintenance, such as harvesting, watering, and providing of fertilizer. In order to regularly perform such maintenance, a user who uses lawns often requests a gardener (also referred to as a landscape gardener) that provides services relating to lawns such as maintenance to manage the lawns. However, under the conventional method, it is difficult to match a gardener who wants to provide the service relating to the lawns with a user (customer) who wants the service relating to the lawns, and to effectively utilize the service relating to the lawns.

It is, therefore, an object of the present invention to provide an information providing system capable of promoting the use of services relating to a lawn.

An information providing system (for example, an information providing system 1 described later) according to the present invention includes: a gardener terminal (for example, a gardener terminal 200 described later); and a customer terminal (for example, a customer terminal 300 described later) communicably connected to the gardener terminal, in which the gardener terminal includes a first fee setting unit (for example, a first fee setting unit 211 described later) that, in a case in which a contract for a transaction relating to a lawn is established between a customer using the customer terminal and a gardener using the gardener terminal, sets a first fee for the transaction relating to the lawn, based on an amount of the lawn produced by the transaction relating to the lawn, and a lawn state information generating unit (for example, a lawn state information generating unit 214 described later) that generates lawn state information including a use state of the lawn and the first fee, and transmits the lawn state information to the customer terminal.

Furthermore, the first fee setting unit sets the first fee to a price calculated by subtracting an amount of money of a first rate from a first price, based on an amount of the lawn.

Furthermore, the gardener terminal further includes a condition determining unit (for example, a condition determining unit 212 described later) that determines whether the customer using the customer terminal satisfies a predetermined customer condition, and a second fee setting unit (for example, a second fee setting unit 213 described later) that, in a case in which the customer satisfies the predetermined customer condition, sets a second fee for the transaction relating to the lawn, based on a fermentation efficiency of fermentation products obtained by fermenting a lawn produced by the transaction relating to the lawn, and wherein the lawn state information includes the use state of the lawn, the first fee, and the second fee.

Furthermore, the second fee setting unit sets the second fee to a price calculated by subtracting an amount of money of a second rate from a second price, based on a fermentation conversion efficiency for producing biogas from the fermentation products.

According to the present invention, it is possible to provide an information providing system capable of promoting the use of services relating to a lawn.

### BRIEF DESCRIPTION OF THE DRAWINGS

FIG. 1 is a schematic diagram showing a relationship among a management company, a gardener, and a customer according to the present embodiment;

FIG. 2 is a diagram showing an example of the configuration of an information providing system according to the present embodiment;

FIG. 3 is a diagram showing an example of the configuration of an information providing device;

FIG. 4 is a diagram showing an example of the configuration of a gardener terminal;

FIG. 5 is a diagram showing a relationship between an amount of a lawn produced by a transaction relating to the lawn, and a rate of subtraction of a fee for the transaction relating to the lawn;

FIG. 6 is a diagram showing a relationship between a fermentation conversion efficiency for producing biogas from lawn fermentation products, and a rate of subtraction of a fee for a transaction relating to a lawn;

FIG. 7 is a diagram showing an example of the configuration of a customer terminal; and

FIG. 8 is a flowchart showing a flow of processing of the information providing system.

### DETAILED DESCRIPTION OF THE INVENTION

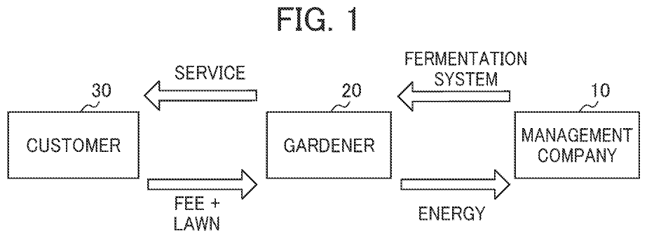

Embodiments of an information providing system of the present invention will be described below with reference to the drawings. FIG. 1 is a schematic diagram showing a relationship among a management company 10, a gardener 20, and a customer 30 according to the present embodiment.

In the present embodiment, the management company 10 provides a fermentation system to the gardener 20 for fermenting the lawn which has been pruned and has become a waste, and generating energy using the fermented product.

The fermentation system includes, for example, a fermentation device for fermenting lawns, a biogas acquisition device for acquiring a biogas such as methane gas, carbon monoxide, or carbon dioxide from a fermented product obtained by fermenting the lawn, an energy generation device for generating hydrogen and energy such as electricity, using the biogas, and an energy storage device for storing the generated energy. The energy generating device has, for example, a reformer for generating hydrogen from biogas and a generator for biogas for generating electricity from biogas. It should be noted that the fermentation system may be provided with another configuration for fermenting lawns to generate energy from the fermented product.

Such a fermentation system is provided or lent from the management company 10 to the gardener 20 for a fee or free of charge. Furthermore, the management company 10 may perform maintenance of the fermentation system or the like for a fee or free of charge. The management company 10 is supplied with energy generated by the fermentation system from the gardener 20.

The gardener 20 is also referred to as a landscape gardener, and provides the customer 30 with lawn management such as periodic lawn mowing and lawn-related services such as lawn rental. Furthermore, the gardener 20 ferments the waste lawn using the fermentation system provided by the management company 10 Thereafter, the gardener 20 uses a fermentation system to generate energy in the form of, for example, hydrogen, electricity, and carbon dioxide from the fermented product.

The gardener 20 grows the lawn in order to provide services relating to the lawn. Thereafter, a used lawn or an unnecessary lawn is used for fermentation as waste. In addition, the gardener 20 may use a solution of fermented lawns or a biogas such as carbon dioxide or the like as a fertilizer for growing lawns.

The customer 30 is, for example, a park management company, a hotel, an event management company, a golf course management company, an individual user, or the like, and receives services relating to lawns from the gardener 20. The customer 30 pays a fee to the gardener 20 as a compensation for services relating to lawns. In addition, the customer 30 provides the gardener 20 with lawns, which are waste generated by management of the lawns such as lawn mowing.

As described above, in the present embodiment, the management company 10, the gardener 20, and the customer 30 have a relationship of giving and receiving services relating to lawns, energy generated from fermented lawns, and compensation for them.

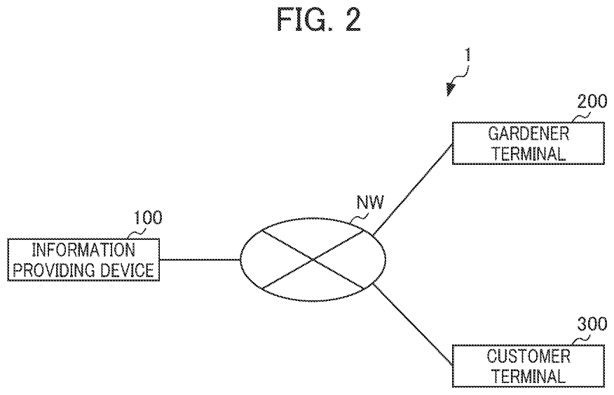

FIG. 2 is a diagram showing an example of a configuration of an information providing system 1 according to the present embodiment. As shown in FIG. 2, the information providing system 1 includes an information providing device 100, a gardener terminal 200, and a customer terminal 300.

The information providing device 100 is used by the management company 10 shown in FIG. 1, and is connected to the gardener terminal 200 and the customer terminal 300 via the network NW so as to be able to communicate with each other.

The gardener terminal 200 is used by the gardener 20 shown in FIG. 1, and is connected to the information providing device 100 and the customer terminal 300 so as to be able to communicate with each other via the network NW. The gardener terminal 200 provides gardener information about services related to lawns to the information providing device 100.

The customer terminal 300 is used by the customer 30 shown in FIG. 1, and is connected to the information providing device 100 and the gardener terminal 200 so as to be able to communicate with each other via the network NW. The customer terminal 300 provides the gardener terminal 200 with request information relating to the lawn.

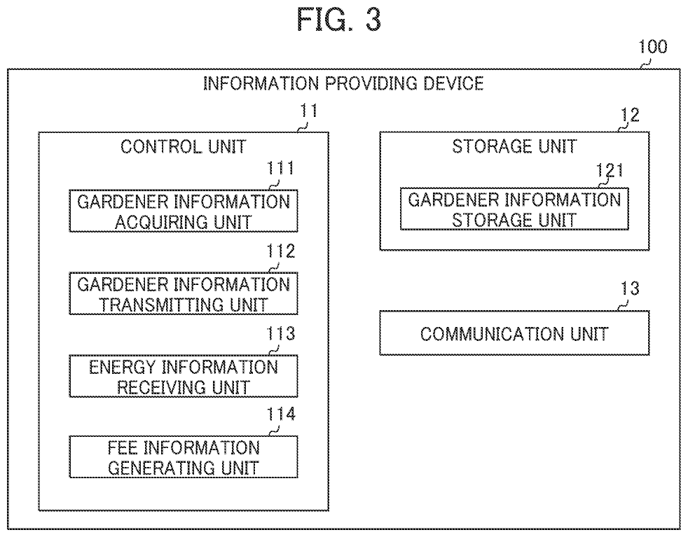

FIG. 3 is a diagram showing an example of a configuration of the information providing device 100. As shown in FIG. 2, the information providing device 100 includes a control unit 11, a storage unit 12, and a communication unit 13.

The control unit 11 is realized by, for example, a hardware processor such as a CPU (Central Processing Unit) executing a program (software). Some or all of these components may be realized by hardware (including a circuit portion) such as an LSI (Large Scale Integration) or an ASIC (Application Specific Integrated Circuit), an FPGA (Field-Programmable Gate Array, or a GPU (Graphics Processing Unit), or may be realized by cooperation of software and hardware. The program may be stored in advance in a storage device such as an HDD (Hard Disk Drive) or flash memory (a storage device including a non-transient storage medium), or may be stored in a removable storage medium such as a DVD or a CD-ROM (a non-transient storage medium) and installed when the storage medium is inserted to a drive device.

The storage unit 12 is realized by, for example, a storage device including a non-transient storage medium such as an HDD (Hard Disk Drive), flash memory, EEPROM (Electrically Erasable Programmable Read Only Memory), ROM (Read Only Memory), or the like, or RAM (Random Access Memory).

The communication unit 13 is a communication interface for communicating with external devices such as the gardener terminal 200 and the customer terminal 300 through the network NW.

Next, the processing of the control unit 11 will be described. As shown in FIG. 3, the control unit 11 includes a gardener information acquiring unit 111, a gardener information transmitting unit 112, an energy information receiving unit 113, and a fee information generating unit 114.

Upon receiving request information from the customer terminal 300, the gardener information acquiring unit 111 refers to the gardener information storage unit 121 to acquire gardener information matching the request information.

Here, the request information includes the content of the service and the fee for the service relating to lawns desired by the customer 30. Furthermore, the request information may include a variety of the lawn provided by the gardener, a type of fertilizer used for the lawn, a method of treating a lawn produced by a transaction relating to the lawn, and energy generated using the lawn, and the like.

The gardener information storage unit 121 stores gardener information received in advance from the gardener terminal 200 and accumulated therein. The gardener information includes the content of services relating to the lawn by the gardener, the fee for the services relating to the lawn, the variety of the lawn provided by the gardener, the type of fertilizer used for the lawn, the method of treating the lawn produced by the transaction relating to the lawn, and the energy produced using the lawn. In addition, the gardener information may further include information such as a service provision time relating to the lawn, a location of the gardener, and the like.

The gardener information transmitting unit 112 transmits the gardener information acquired by the gardener information acquiring unit 111 to the customer terminal 300. The gardener information transmitted to the customer terminal 300 allows the customer 30 using the customer terminal 300 to determine with which gardener 20 to contract.

The energy information receiving unit 113 receives the energy information including the data of the energy amount of the energy generated using the lawn produced by the transaction relating to the lawn from the gardener terminal 200 when the transaction relating to the lawn is concluded between the customer 30 using the customer terminal 300 and the gardener 20 using the gardener terminal 200. It should be noted that the information providing device 100 generates contract information indicating the conclusion of a contract for a transaction relating to the lawn, and transmits the contract information to the gardener terminal 200 and the customer terminal 300 relating to the transaction relating to the lawn. Furthermore, the contract information may be generated by the gardener terminal 200 and/or the customer terminal 300, and transmitted to the information providing device 100, the gardener terminal 200, and the customer terminal 300 relating to the transaction relating to the lawn.

More specifically, the energy information receiving unit 113 receives, from the gardener terminal 200 for which the contract has been established, energy information including the energy amount of the energy generated by fermenting the lawn produced by the transaction relating to the lawn and using the fermented product.

Here, the transaction relating to the lawn includes providing the customer 30 with, for example, the management of the lawn such as periodic lawn mowing and services relating to the lawn such as rental of the lawn from the gardener 20, and the payment of a fee from the customer 30 to the gardener 20 in compensation of the services relating to the lawn. Furthermore, the energy information includes, for example, data relating to the energy amount and the energy type of the energy generated by using the fermented product.

The fee information generating unit 114 generates fee information according to the energy amount, and transmits the fee information to the gardener terminal 200. Here, the fee information includes, for example, a predetermined price corresponding to the energy amount, and a commission. Furthermore, in a case in which the energy amount is equal to or greater than a predetermined amount, the fee information generating unit 114 sets a price calculated by subtracting the amount of money corresponding to the energy amount from a predetermined price.

For example, suppose that the gardener 20 who uses the gardener terminal 200 has a contract with the management company 10 that uses the information providing device 100 to store 20 kW of electricity per month as electrical energy and to pay a predetermined price for the rental of a fermentation system.

In this case, the fee information generating unit 114 determines whether the energy amount in the energy information transmitted from the gardener terminal 200 is 20 kW or more per month. When the energy amount is 20 kW or more per month, the fee information generating unit 114 sets a price calculated by subtracting the amount of money corresponding to the energy amount exceeding 20 kW from a predetermined price. In other words, the fee information generating unit 114 sets the amount of money corresponding to the energy amount to a price that is discounted from the predetermined price.

Furthermore, in a case in which the energy amount falls below a predetermined amount, the fee information generating unit 114 sets a price calculated by adding the amount of money corresponding to the energy amount to a predetermined price. For example, when the energy amount is less than 20 kW per month, the fee information generating unit 114 sets a price calculated by subtracting the amount of money corresponding to the energy amount less than 20 kW from a predetermined price. In other words, the fee information generating unit 114 sets the price calculated by increasing the amount of money corresponding to the energy amount from the predetermined price.

Furthermore, in a case in which the amount of money corresponding to the energy amount is set to a price obtained by adding to or subtracting from a predetermined price by the information providing device 100, the gardener terminal 200 may update the rate information to be presented to the customer terminal 300 based on the information about the price.

For example, in a case in which the amount of money corresponding to the energy amount is set to a price obtained by subtracting from a predetermined price by the information providing device 100, the gardener terminal 200 may set the price to be presented to the customer terminal 300 to a price discounted from the normal price based on the information about the price, and update the price information.

Furthermore, the energy generated using the lawn from the transaction relating to the lawn may be sold to third parties other than the management company 10, the gardener 20, or the customer 30. For example, the hydrogen and electricity generated using the lawn may be sold to third parties such as power companies, service stations that supply energy, and individuals who use the energy.

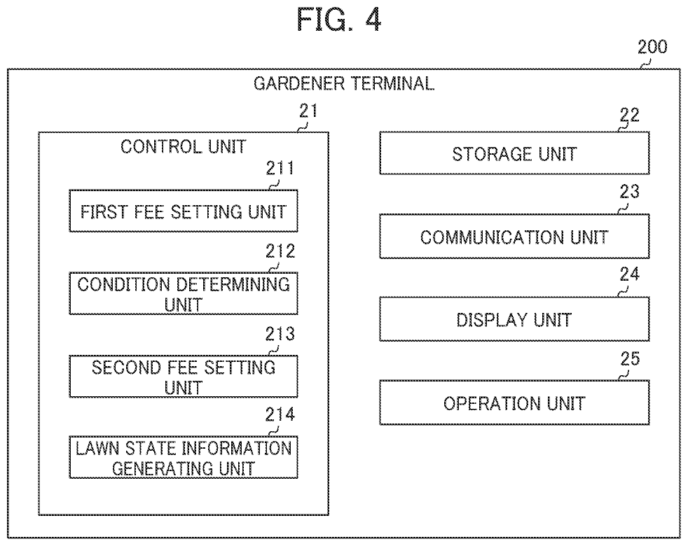

FIG. 4 is a diagram showing an example of the configuration of the gardener terminal 200. As shown in FIG. 4, the gardener terminal 200 includes a control unit 21, a storage unit 22, a communication unit 23, a display unit 24, and an operation unit 25.

The control unit 21 is realized by, for example, a hardware processor such as a CPU (Central Processing Unit) executing a program (software). Some or all of these components may be realized by hardware (including a circuit portion) such as an LSI (Large Scale Integration) or an ASIC (Application Specific Integrated Circuit), an FPGA (Field-Programmable Gate Array, or a GPU (Graphics Processing Unit), or may be realized by cooperation of software and hardware. The program may be stored in advance in a storage device such as an HDD (Hard Disk Drive) or flash memory (a storage device including a non-transient storage medium), or may be stored in a removable storage medium such as a DVD or a CD-ROM (a non-transient storage medium) and installed when the storage medium is inserted to a drive device.

The storage unit 22 is realized by, for example, a storage device including a non-transient storage medium such as an HDD (Hard Disk Drive), flash memory, EEPROM (Electrically Erasable Programmable Read Only Memory), ROM (Read Only Memory), or the like, or RAM (Random Access Memory).

The communication unit 23 is a communication interface for communicating with the information providing device 100 and external devices such as the customer terminal 300 through the network NW. The display unit 24 is a device for displaying an image. The display unit 24 is, for example, an LCD, an organic EL, or the like.

The operation unit 25 includes a button or the like for operating the display unit 24. In addition, the display unit 24 and the operation unit 25 may be a touch screen in which these functions are integrally provided. In this case, the operation unit 25 may be a GUI switch to be displayed on the display unit 24. Furthermore, the operation unit 25 may be a mechanical button.

Next, the processing of the control unit 21 will be described. As shown in FIG. 4, the control unit 21 includes a first fee setting unit 211, a condition determining unit 212, a second fee setting unit 213, and a lawn state information generating unit 214.

In a case in which a contract for the transaction relating to the lawn is established between the customer 30 using the customer terminal 300 and the gardener 20 using the gardener terminal 200, the first fee setting unit 211 sets the first fee for the transaction relating to the lawn based on the amount of lawn produced by the transaction relating to the lawn. More specifically, the first fee setting unit 211 sets the first fee to a price calculated by subtracting the amount of money of a first rate from a first price serving as a basic fee.

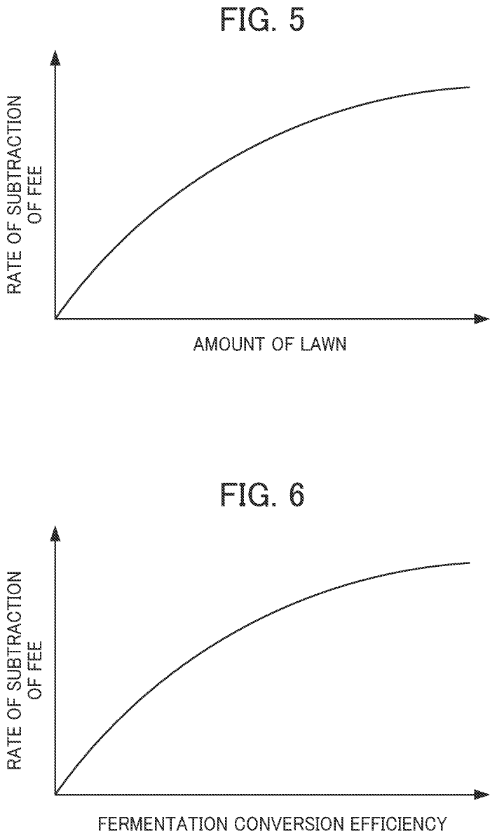

FIG. 5 is a diagram showing a relationship between an amount of a lawn produced by a transaction relating to the lawn and a rate of subtraction of a fee for the transaction relating to the lawn. As shown in FIG. 5, the first fee setting unit 211 increases the value of the first rate to be subtracted from the first price, in accordance with an increase of the amount of lawn produced by the transaction relating to the lawn. In other words, in the first fee for the transaction relating to the lawn, the discount rate that is discounted from the first price increases as the amount of lawn increases.

The condition determining unit 212 determines whether the customer 30 using the customer terminal 300 satisfies a predetermined customer condition. Here, the predetermined customer condition may be that the customer 30 using the customer terminal 300 is a paid member of a service relating to the lawn provided by the gardener 20. Furthermore, for example, when the customer 30 becomes a paid member of the service relating to a lawn, the value of the first rate subtracted from the first price becomes greater than that of a non-paid member of the service relating to the lawn.

In a case in which the customer 30 satisfies a predetermined customer condition, the second fee setting unit 213 sets a second fee for the transaction relating to a lawn based on a fermentation efficiency of fermentation products obtained by fermenting the lawn produced by the transaction relating to the lawn. In this case, the lawn state information includes the use condition of the lawn, the first fee, and the second fee.

Furthermore, the second fee setting unit 213 sets the second fee for paid members to a price calculated by subtracting the amount of money of a second rate from a second price serving as a basic fee, based on the fermentation conversion efficiency for producing biogas from the fermentation products.

FIG. 6 is a diagram showing the relationship between a fermentation conversion efficiency for producing biogas from lawn fermentation products and a subtraction rate of a fee in a transaction relating to a lawn. As shown in FIG. 6, the second fee setting unit 213 increases the value of the second rate to be subtracted from the second price in accordance with an increase of the fermentation efficiency. In other words, in the second fee for the transaction relating to the lawn, the discount rate that is discounted from the second price increases as the fermentation conversion efficiency increases.

Here, the fermentation conversion efficiency varies depending on the type of fertilizer used to grow the lawn. The gardener 20 can choose to use a fertilizer that makes it easier for the lawn to grow or a fertilizer that improves the fermentation conversion efficiency.

The lawn state information generating unit 214 generates the lawn state information including the use state of the lawn and the first fee, and transmits the information to the customer terminal 300. Furthermore, when the customer 30 satisfies a predetermined customer condition, the lawn state information generating unit 214 generates the lawn state information including the use state of the lawn, the first fee, and the second fee, and transmits the information to the customer terminal 300.

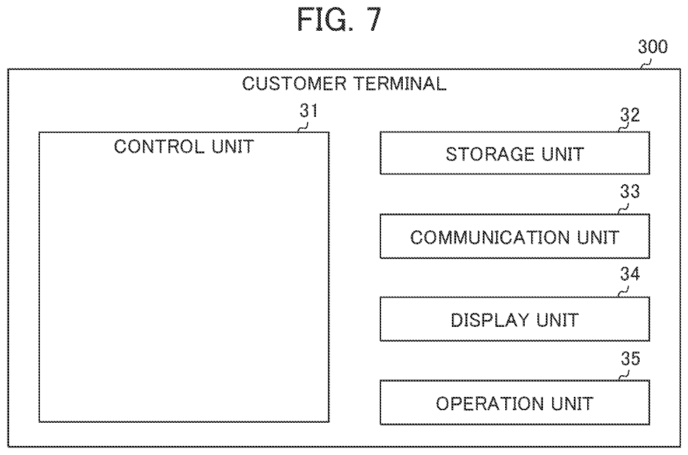

FIG. 7 is a diagram showing an example of the configuration of the customer terminal 300. As shown in FIG. 7, the customer terminal 300 includes a control unit 31, a storage unit 32, a communication unit 33, a display unit 34, and an operation unit 35.

The control unit 31 is realized by, for example, a hardware processor such as a CPU (Central Processing Unit) executing a program (software). Some or all of these components may be realized by hardware (including a circuit portion) such as an LSI (Large Scale Integration) or an ASIC (Application Specific Integrated Circuit), an FPGA (Field-Programmable Gate Array, or a GPU (Graphics Processing Unit), or may be realized by cooperation of software and hardware. The program may be stored in advance in a storage device such as an HDD (Hard Disk Drive) or flash memory (a storage device including a non-transient storage medium), or may be stored in a removable storage medium such as a DVD or a CD-ROM (a non-transient storage medium) and installed when the storage medium is inserted to a drive device.

The storage unit 32 is realized by, for example, a storage device including a non-transient storage medium such as an HDD (Hard Disk Drive), flash memory, EEPROM (Electrically Erasable Programmable Read Only Memory), ROM (Read Only Memory), or the like, or RAM (Random Access Memory).

The communication unit 33 is a communication interface for communicating with the information providing device 100 and external devices such as the gardener terminal 200 through the network NW. The display unit 34 is a device for displaying an image. The display unit 34 is, for example, an LCD, an organic EL, or the like.

The operation unit 35 includes a button or the like for operating the display unit 34. In addition, the display unit 34 and the operation unit 35 may be a touch screen in which these functions are integrally provided. In this case, the operation unit 35 may be GUI switches displayed on the display unit 34. Furthermore, the operation unit 35 may be mechanical buttons.

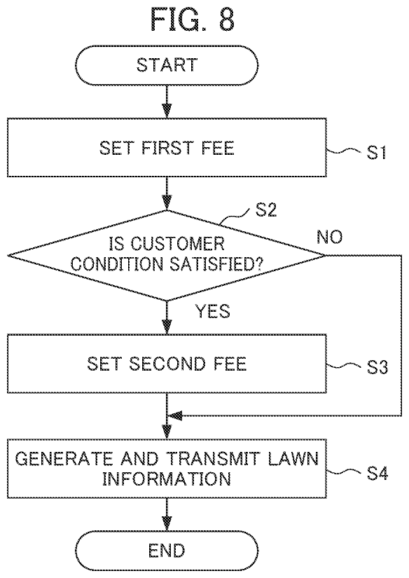

FIG. 8 is a flowchart showing the flow of processing of the information providing system 1. In step S1, the first fee setting unit 211 sets the first fee for the transaction relating to the lawn, based on the amount of lawn produced by the transaction relating to the lawn.

In step S2, the condition determining unit 212 determines whether the customer 30 using the customer terminal 300 satisfies a predetermined customer condition. In a case in which the customer 30 satisfies a predetermined customer condition (YES), the processing advances to step S3. On the other hand, in a case in which the customer 30 does not satisfy the predetermined customer condition (NO), the processing advances to step S4.

In step S3, the second fee setting unit 213 sets the second fee for the transaction relating to the lawn, based on the fermentation efficiency of the fermentation products obtained by fermenting the lawn produced by the transaction relating to the lawn.

In step S4, the lawn state information generating unit 214 generates the lawn state information including the use state of the lawn and the first fee, and transmits the information to the customer terminal 300. Furthermore, in a case in which the customer 30 satisfies a predetermined customer condition, the lawn state information generating unit 214 generates the lawn state information including the use state of the lawn, the first fee, and the second fee, and transmits the information to the customer terminal 300.

According to the present embodiment, the following effects can be achieved, for example. The information providing system 1 includes the gardener terminal 200 and the customer terminal 300 communicably connected to the gardener terminal 200. The gardener terminal 200 includes the first fee setting unit 211 that, in a case in which a contract for a transaction relating to a lawn is established between the customer 30 using the customer terminal 300 and the gardener 20 using the gardener terminal 200, sets a first fee for the transaction relating to the lawn, based on an amount of the lawn produced by the transaction relating to the lawn, and the lawn state information generating unit 214 that generates lawn state information including a use state of the lawn and the first fee, and transmits the lawn state information to the customer terminal 300.

With such a configuration, the customer 30 using the customer terminal 300 can obtain the lawn state information including the use state of the lawn and the first fee from the gardener terminal 200. Therefore, it is possible to promote the use of the service relating to the lawn between the gardener 20 and the customer 30.

Furthermore, the first fee setting unit sets the first fee to a price calculated by subtracting an amount of money of a first rate from a first price, based on an amount of the lawn. With such a configuration, it is possible for the gardener terminal 200 to discount the first fee for the transaction relating to the lawn based on the amount of the lawn.

The gardener terminal 200 further includes the condition determining unit 212 that determines whether the customer 30 using the customer terminal 300 satisfies a predetermined customer condition, and the second fee setting unit 213 that, in a case in which the customer 30 satisfies the predetermined customer condition, sets a second fee for the transaction relating to the lawn, based on a fermentation efficiency of fermentation products obtained by fermenting a lawn produced by the transaction relating to the lawn, and the lawn state information includes the use state of the lawn, the first fee, and the second fee. With such a configuration, it is possible for the gardener terminal 200 to present the second fee for the transaction relating to the lawn to the customer 30 who satisfies a predetermined customer condition. Therefore, it is possible to further promote use of the service relating to the lawn between the gardener 20 and the customer 30.

Furthermore, the second fee setting unit 213 sets the second fee to a price calculated by subtracting an amount of money of a second rate from a second price, based on a fermentation conversion efficiency for producing biogas from the fermentation products. With such a configuration, it is possible for the gardener terminal 200 to discount the second fee for the transaction relating to the lawn based on the fermentation conversion efficiency.

While an embodiment of the present invention has been described above, the present invention is not intended to be limited thereto. Within the spirit of the present invention, the details of the configuration may be modified as appropriate.

### EXPLANATION OF REFERENCE NUMERALS

1 information providing system
100 information providing device
200 gardener terminal
211 first fee setting unit
212 condition determining unit
213 second fee setting unit
214 lawn state information generating unit
300 customer terminal

1. An information providing system comprising:
a gardener terminal; and
a customer terminal communicably connected to the gardener terminal,
wherein the gardener terminal includes
a first fee setting unit that, in a case in which a contract for a transaction relating to a lawn is established between a customer using the customer terminal and a gardener using the gardener terminal, sets a first fee for the transaction relating to the lawn, based on an amount of the lawn produced by the transaction relating to the lawn, and
a lawn state information generating unit that generates lawn state information including a use state of the lawn and the first fee, and transmits the lawn state information to the customer terminal.

2. The information providing system according to claim 1, wherein the first fee setting unit sets the first fee to a price calculated by subtracting an amount of money of a first rate from a first price, based on an amount of the lawn.

3. The information providing system according to claim claim 1, wherein the gardener terminal further includes
a condition determining unit that determines whether the customer using the customer terminal satisfies a predetermined customer condition, and
a second fee setting unit that, in a case in which the customer satisfies the predetermined customer condition, sets a second fee for the transaction relating to the lawn, based on a fermentation efficiency of fermentation products obtained by fermenting a lawn produced by the transaction relating to the lawn, and
wherein the lawn state information includes the use state of the lawn, the first fee, and the second fee.

4. The information providing system according to claim 3, wherein the second fee setting unit sets the second fee to a price calculated by subtracting an amount of money of a second rate from a second price, based on a fermentation conversion efficiency for producing biogas from the fermentation products.

5. The information providing system according to claim 2, wherein the gardener terminal further includes
a condition determining unit that determines whether the customer using the customer terminal satisfies a predetermined customer condition, and
a second fee setting unit that, in a case in which the customer satisfies the predetermined customer condition, sets a second fee for the transaction relating to the lawn, based on a fermentation efficiency of fermentation products obtained by fermenting a lawn produced by the transaction relating to the lawn, and
wherein the lawn state information includes the use state of the lawn, the first fee, and the second fee.

6. The information providing system according to claim 5, wherein the second fee setting unit sets the second fee to a price calculated by subtracting an amount of money of a second rate from a second price, based on a fermentation conversion efficiency for producing biogas from the fermentation products.
